(19) United States
(12) Patent Application Publication
(10) Pub. No.: US 2007/0162328 A1
(43) Pub. Date: Jul. 12, 2007

(54) Lbs nowcasting sensitive advertising and promotion system and method

(75) Inventor: Yaron Reich, Herzlia (IL)

Correspondence Address: SULLIVAN & WORCESTER LLP, ONE POST OFFICE SQUARE, BOSTON, MA, 02109, US

(73) Assignee: NOOLY TECHNOLOGIES, LTD., Herzlia (IL)

(21) Appl. No.: 10/587,002

(22) PCT Filed: Jan. 20, 2005
(86) PCT No.: PCT/IL05/00075

§ 371 Date: Jul. 20, 2006

Related U.S. Application Data
(60) Provisional application No. 60/537,032, filed on Jan. 20, 2004.

(51) Int. Cl. G06Q 30/00

(52) U.S. Cl. 705/14

(57) ABSTRACT

A system and method for combining the delivery of advertising with weather predictions that are limited in geo-graphical area and time, and hence which are much more precise but also more time sensitive than regular weather forecasts. The present invention is preferably implemented with “nowcasting”.

### FIELD OF THE INVENTION

The present invention relates to a system and method for combining the delivery of weather information with advertising.

### BACKGROUND OF THE INVENTION

Weather is an inherent part of every human activity, from traveling to working outdoors, commuting and even enjoying walking or other outdoor sports activities. Currently, weather predictions are made on a large scale, for a large geographical area and also for a relatively long period of time. These predictions are frequently inaccurate.

More accurate weather predictions would clearly be more useful. One method to overcome inaccuracies of weather predictions is described in PCT Application No. WO 02/49310 to Nooly Technologies Inc., hereby incorporated by reference as if fully set forth herein. This method provides predictions in a geographically limited area (typically up to about 10 km, although much smaller areas of from about 1 km to about 5 km may also be examined for such weather predictions), which are of a much higher accuracy than regular, large area predictions. Depending upon the time period over which the prediction is given, the accuracy of the weather prediction may exceed 90%, which is clearly much more useful.

The delivery method, however, is only briefly described in the above PCT application. Furthermore, delivering weather information which relates to relatively small geographical areas and relatively short time spans is clearly important, since if the material is not timely delivered, the time period for the prediction may expire before the individual receives the necessary information. Therefore, improved methods and systems for delivery of weather information are clearly required.

### SUMMARY OF THE INVENTION

The background art does not teach or suggest a system or method for combining advertising with weather information, in which the weather information is related to a geographically defined area and a predefined period of time. The background art also does not teach or suggest delivery of advertising with weather nowcasting information.

The present invention overcomes these deficiencies of the background art, by providing a system and method for combining the delivery of advertising with weather predictions that are limited in geographical area and time, and hence which are much more precise but also more time sensitive than regular weather forecasts. The present invention is preferably implemented with “nowcasting”, which is a system and method for weather prediction described in PCT Application No. WO 02/49310 to Nooly Technologies Inc., hereby incorporated by reference as if fully set forth herein.

### BRIEF DESCRIPTION OF THE DRAWINGS

The invention is herein described, by way of example only, with reference to the accompanying drawings, wherein:

FIG. 1 shows an exemplary system according to the present invention;

FIG. 2 shows an exemplary rule engine according to the present invention;

FIG. 3 shows an exemplary advertising matrix according to the present invention;

FIG. 4 shows an exemplary logic flow diagram for the rule engine according to the present invention;

FIG. 5 shows an exemplary advertisement and promotion building logic flow diagram according to the present invention;

FIG. 6 shows an exemplary logic flow diagram for advertiser feedback according to the present invention;

FIG. 7 shows an exemplary logic flow diagram for preparing reports for the advertiser according to the present invention;

FIG. 8 shows an example of location based advertising with the effective temperature for a specific location; in the example, every cola bottle represents a time period of 20 minutes, such that the graph shows the temperature evolution over a period of 2 hours and twenty minutes. Since in the specific device that is used there may be a font size limitation, numbers are not written but are instead optionally represented in the form of red lines (every red line represents 5 minutes) when the temperature at the first bottle is 20 degrees; and

FIG. 9 shows an illustrative, non-limiting system according to the present invention, featuring Rule Engine integration with a CDMA 2000 network (3 G network).

### DESCRIPTION OF THE PREFERRED EMBODIMENTS

The present invention is of a system and method for combining the delivery of advertising with weather predictions that are limited in geographical area and time, and hence which are much more precise but also more time sensitive than regular weather forecasts. The present invention is preferably implemented with “nowcasting”.

Preferred embodiments of the present invention permit an advertisement to be selected according to predicted weather, preferably also according to at least one weather related characteristic. For example, the weather related characteristic may determine that for a particular weather prediction, a selected advertisement is preferably sent to an end user. The weather prediction may optionally involve a range of temperatures for example, and/or another group of weather characteristics, such as relevant weather parameters and other meteorological parameters, including but not limited to, fog, hail (in various sizes and intensities), snow (light, heavy and/or with accumulation possibilities, which for example could be used to tie a certain advertisement campaign to the first accumulated snow, optionally including coupons), pollution level (including various types of pollution and the various effects it has on different groups in the population e.g. infants, people with asthma etc.), wind speed at different altitudes, suntan (duration of time to remain in the sun before burning, presence of sufficient sun to suntan, warnings), effective temperatures (wind chill factor, heat stress), and frost. In addition, parameters may also be related to sport and outdoor activities, including but not limited to, surfing, bicycling, fishing, skiing, gliding, parachuting, boating etc.

The end user may optionally and preferably receive the advertisement through a variety of media; for example, as a text message on a cellular telephone, paging device, via a Web-based application, electronic advertising board, smart devices (based on Bluetooth/WiFi and the like) such as watches, Palms, refrigerators (that are so enabled and can receive relevant daily information, whether through a wired or wireless connection), home entertainment devices (such as DVD, X-Box, Play-station and the like), Interactive TV, car embedded or mounted devices, sales points (including cash-registers, sales point electronic display, integrated into a third party device, systems database and the like or other portable electronic device), as a still picture or pictures or elements that are imbedded into 3^{rd} party picture/image (for example, in a situation in which a weather related component/advertisement is added to a pre existing picture, advertisement, movie etc.) as well as textual or numerical information provided through a website by using XML, optionally on a portable electronic device that is capable of supporting such pictures (for example, one of the previously listed devices), as video data on a portable electronic device that is capable of supporting such video (for example, one of the previously listed devices), through a GUI on a computational device such as a PC computer for example, or through any other suitable electronic device.

The advertisement media is preferably selected at least partially according to the electronic device to which it is to be delivered, so that the characteristics of the media are supported by the device. Optionally and preferably, the advertisement itself is selected also according to at least one characteristic of the end user. Optionally, the end user may submit such a characteristic through a GUI or other interface, or through any other type of communication. Examples of such user characteristics include but are not limited to, user skin type including various sensitivities (ability to withstand the sun for a person with dark skin), hair type, eye color etc. (for sensitivity to sun and heat), user age (optionally including age groups e.g. student, college student, business people, retired, young mothers etc.), marital status (married, engaged, searching for a mate etc.), various user hobbies including but not limited to favorite sport, favorite team etc. health related issues (including weight, allergies, heart problems etc.), eating habits, fashion and clothing preferences, consuming habits etc.

Optionally and preferably, the user may submit relevant details through a variety of mechanisms, including but not limited to, through a human sales representative, as a response for a coupon or as a accumulated purchase (for example when a user is offered a free/discounted product such as beverage, the user may be offered a coupon of several products, and then needs to chose one product from the product list, thereby providing information about favored brands and/or types of products), using wireless 3 G or website GUIs (graphical user interfaces), using information gathered by third parties such through participation by the user in an interactive game (in which the user make logical choices that represent consumer information).

Some preferred embodiments of the present invention are described in greater detail below.

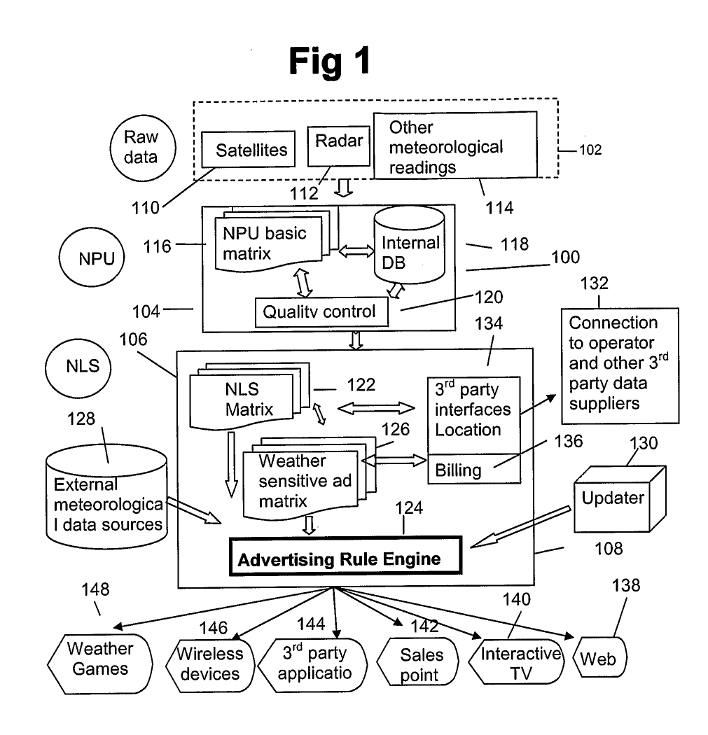

FIG. 1 shows a system according to the present invention, with a weather sensitive advertising matrix for providing advertisements according to predicted weather. As shown, a system 100 features a data input 102, a weather processor 104, an NLS 106 and one or more external interfaces 108 for providing advertisements, for example to an end user.

Data input 102 may optionally include any type of information related to meteorological analysis and may optionally be received from a variety of different instruments for providing such data, including but not limited to, a satellite 110, radar 112 or other meteorological readings 114 including meteorological models, as well as 3^{rd} party (such as regional meteorological service) forecast. This data is used as input for the preparation of the Nowcasting forecast as well for the present invention. Weather processor 104 receives data from data input 102 and analyzes this data in order to provide “nowcasting” weather prediction. Weather processor 104 features a NPU basic matrix 116, an internal database 118 and a quality control module 120. NPU basic matrix 116 and internal database 118 preferably contain a plurality of meteorological, physics meteorology, and statistical algorithms that track current status of the basic meteorological parameters and calculate the predicted evolution of those parameters (rain, heat, humidity, pollution, wind, etc.) as well as all other additional weather parameters that are resulted from the above parameters (frost, effective temperature, time and/or ability to suntan (sun exposure), etc.). Physics meteorology uses physics in algorithms to predict meteorological phenomena such as cloud formation, interactions between the sea and land and so forth. Quality control module 120 is preferably used in order to provide feedback and adjust the prediction according to historical, current and third party (internal and external) predictions.

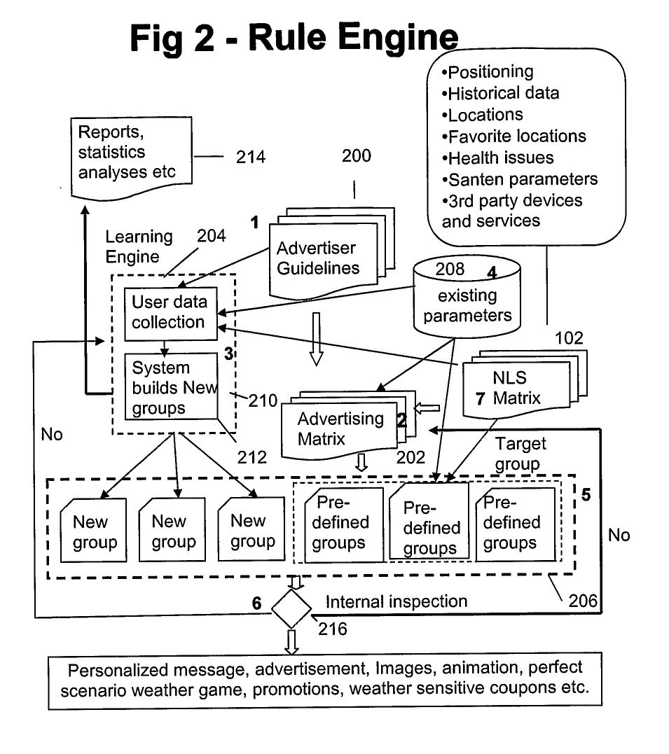

NLS (Nowcasting Local Server) 106 optionally and preferably contains the advertising system for providing advertisements. NLS 106 receives the weather prediction from weather processor 104, preferably (as noted above) as a near term weather prediction or a “nowcasting” prediction. NLS 106 preferably features a NLS matrix 122 for receiving the weather prediction information and for processing it Rule engine 124 is not limited to operation with NLS 106 (for example, rule engine 124 could optionally operate with other weather systems, including but not limited to the WeatherBug (www.weatherbug.com), and/or the Weather Channel system). Rule engine 124 obtains accurate location based Nowcasting from NLS 106 (or other meteorological parameters from a third party). Rule Engine 124 also preferably obtains user details from NLS matrix 122 as well as from an external system 132 as described below (such as location, billing, information from other applications, device features and so forth). NLS matrix 122 then preferably provides the weather prediction information to rule engine 124 for selecting at least one advertisement. Rule engine 124 is described in greater detail with regard to FIG. 2.

Briefly, advertising rule engine 124 preferably receives the weather prediction information and then selects an advertisement according to at least one rule. More preferably, the advertisement is selected according to at least one rule related to the weather prediction information and also according to at least one rule related to a characteristic of an end user for receiving the advertisement through external interface 108. The rule or rules may optionally be correlated with one or more advertisements through a weather sensitive ad matrix 126, also described in greater detail with regard to FIG. 2.

Advertising rule engine 124 is also optionally in communication with one or more external meteorological data sources 128 including but not limited to a national meteorological agency, independent meteorological supplier (such as the WeatherBug, weather channels in the US and other countries) that supply their own weather readings and predictions (such as 10 days to first frost) or even from “private” sources (such as universities or hobbyists for example) that collect meteorological data for receiving additional weather prediction information. Advertising rule engine 124 is also optionally in communication with an updater 130 for receiving updated advertisements and/or rules and/or end user characteristics, for example from an advertiser (not shown); the advertiser receives an online report from rule engine 124 and can optionally respond to that by adding and/or changing relevant parameters and rules for determining when/to whom an advertisement is displayed. The advertiser can optionally initiate changes to a campaign or a new advertising campaign. Advertising rule engine 124 is also optionally in communication with an external system 132, which may for example include an operator and/or third party data suppliers. Communication with external system 132 is preferably performed through a third party interface 134, which may optionally include a billing module 136 as shown.

The advertisement is preferably provided to the end user through an external interface 108, which as shown may include one or more of a Web page 138, interactive television 140, a sales point 142 (optionally including but not limited to a computerized cash register, a store, some type of advertising method (like a billboard next to a sales counter) and so forth), a third party application 144 (optionally any application that could integrate the personalized weather advertising into a third party system including but not limited to, a supermarket internal advertising system that can integrate advertisements produced according to the present invention, and/or components thereof, into their advertising system and database;, a wireless device 146 or a weather game 148, described in greater detail below. Generally weather games relate to a series of games which all use weather as part of the game, typically in which the user should guess a certain meteorological parameter for a given location at a certain time or a period of time; non-limiting examples including guessing the temperature in a certain location at a given time, how much rain will fall and where will a particular storm hit. A weather game could also feature weather integrated as a central factor, such as for a daily game/contest for matching the right/best clothing (fashion wise) to various people (optionally chosen from people at various locations and various ages; the person could optionally be a celebrity, random person, a virtual person etc.) with regard to geographical location, planned activities and the weather. All of the above are intended as non-limiting examples of suitable external interfaces 108 through which the end user may receive the advertisement.

FIG. 2 shows advertising rule engine 124 in greater detail. Rule Engine 124 optionally and preferably operates through a combination of several different matrixes, various databases and information provided through the location-base Nowcasting (described in the previously incorporated PCT application to Nooly Technologies Inc.). Rule Engine 124 preferably maximizes the effect of an advertising campaign according to one or more of specific consumer groups or specific products, and also according to the weather. More preferably, this is accomplished by maximizing the user experience through the provision of vivid, enjoyable, low cost personalized weather related information. Rule engine 124 preferably receives one or more advertiser guidelines 200, which relate to the advertiser rules according to which the advertiser wishes to have a particular advertisement transmitted. These rules preferably include at least one characteristic related to the weather, but more preferably also include at least one characteristic related to the end user/group of users. These advertiser rules are preferably transmitted to an advertising matrix 202. Advertising matrix 202 preferably correlates the advertiser rules, weather prediction information received from NLS matrix 122 and also at least one characteristic about the end user from a learning engine 204. This information and rules are preferably correlated in order to select an advertisement and at least one end user to receive the advertisement. The end users are then preferably sorted into a plurality of target groups 206 for receiving some type of advertisement according to the weather, with the nature of the advertisement preferably being determined according to the analysis by advertising matrix 202. For example, the advertisement could optionally and preferably be selected from the group including personalized messages, advertisements, images, animation, perfect scenario (described in greater detail below with regard to advertisement examples), weather game, promotions, weather sensitive coupons and so forth.

The at least one user characteristic may optionally be retrieved from a user characteristic database 208, which optionally and preferably includes location information (including but not limited to favorite location of the end user, past end user locations, third party location of importance to the user etc.), various useful historical data with regards to the user/other users with similar features etc., relevant meteorological and personal correlations (such as sun sensitivity or ability to suntan, pollen/pollution sensitivities, sensitivity to weather conditions such as rain, hail, effective temperature etc.), device features, information related to past end user performance (for example with a coupon) and so forth.

Learning engine 204 preferably assists in the collection, analysis and retrieval of end user information. Learning engine 204 preferably features a user data collection module 210 and a group builder module 212. User data collection module 210 may optionally collect data from a wide variety of sources, including but not limited to information provided directly by the end user (for example through a survey or other collection method, through on-line interactions and/or through other actions), data provided by the advertiser and demographic data, which may for example be related to end users living in certain geographical area and/or of a certain age, with or without children, and so forth. Group builder module 212 preferably then builds target groups 206 according to the end user characteristics and also according to weather information provided by NLS matrix 122, and optionally also according to advertiser guidelines 200 (advertising strategy). Group builder module 212 may also optionally issue one or more reports or analyses 214, for example to inform an advertiser about the general characteristics of end users who received a particular advertising message.

Once target groups 206 and the relevant advertisements have been selected, preferably an internal inspection module 216 adjusts the advertisement itself according to one or more parameters of the end user device (for example, characteristics of a cellular telephone) and then the advertisement is transmitted. Internal inspection module 216 preferably includes a set of rules for governing the automatic message, for example with regard to logic and/or potentially offensive message texts and/or animations.

According to optional but preferred embodiments of the present invention the advertiser can choose to use one or more existing predefined consumer groups for target groups 206. Alternatively, the advertiser can request the system according to the present invention to build a new group based on one or more specifications. Similarly, the advertiser can use existing parameters in the system about the users, which may include one or more of the following characteristics: age, gender, location, skin type, allergy etc. as well as parameters that are available from affiliates and/or other third party applications and databases, and/or the advertiser can ask learning engine 204 to learn about its potential customers' consuming habits and product preferences.

Product preferences preferably relate to a particular product, more preferably according to brand loyalty, general product characteristics and so forth; for example a soft drink manufacturer would want to know what kind of soft drinks the customers enjoy, the flavors and brands, whether they are diet drinks and products, and so forth.

According to preferred embodiments of the present invention, learning engine 204 performs analyses of the end user data for the advertiser and/or according to requests from the advertiser. Learning engine 204 allows the advertiser to build new groups and subgroups and to gather as much information on the specific group and or individual in the group for maximizing the advertising campaign. Preferably, learning engine 204 periodically examines the various groups and the individuals that are members in those groups, against the various group definitions to see whether the individual still fits the group definition or may be more suitable with another group or subgroup.

Use of coupons and various promotion methods is also supported through learning engine 204, which can be used to induce an end user to provide more information and/or to participate in a campaign of some type. For example, learning engine 204 could invite such a user to receive a free cold beverage at a nearby beverage company stand. At this point, the probability that the user will use the coupon is higher than that obtained with currently employed methods, due to the environmental conditions and the effect on the user decision process. In return for the free beverage, the user will be asked to answer several questions such as: do you prefer diet drinks, what's your favorite taste etc. It is also logical to assume that the user will use the coupons and will choose his or her favorite beverage (the process could optionally be repeated in order to obtain higher accuracy). Preferred embodiments of the present invention permit such coupons to be provided in any case according to guidelines of the advertiser. Also optionally and preferably, a coupon may incorporate questions to be answered, including selecting a drink option, as a dynamic coupon.

Optionally, the system may offer a free service, in which the users are offered a free (optionally advertisement sponsored) service in return for their participation in a survey/questionnaire (electronic or written). The questionnaire will include data for use in the process of group (and sub group) definition as well as data that will allow building a tailor-made promotion campaign base on the single user's hobbies, family or marital status, health and other preferences.

Optionally in cooperation with internal inspection module 216 (in the form of rules and data sharing), learning engine 204 conducts a periodic survey among the weather base advertisement sponsored (and non advertisement sponsored) personalized forecast and Nowcasting. For example, the system preferably is capable of determining whether the user finds the advertisement offending, if there was a change in the user preferences for products, preferences regarding the presentation of the forecast/nowcast etc.

Learning engine 204 preferably checks the relationship between the weather and consuming habits, and builds a personal weather consuming profile for every user that is in the system. Learning engine 204 also preferably periodically samples existing profiles in order to adjust them with regard to the right advertising group or subgroup.

According to other preferred embodiments of the present invention, advertising matrix 202 generates the advertisement from a message received from the advertiser. The message does not need to be a full message, but rather part of a total message that is unique to the special group included in target group 206. The overall message is also preferably considered in the context of the advertising campaign and also with regard to the special sensitivities or needs of particular groups, such as handicapped users, different religious groups, different age groups and/or other groups have particular sensitivities or needs. Also, the message is preferably targeted according to particular user preferences, for example for diet drinks over regular soft drinks and so forth.

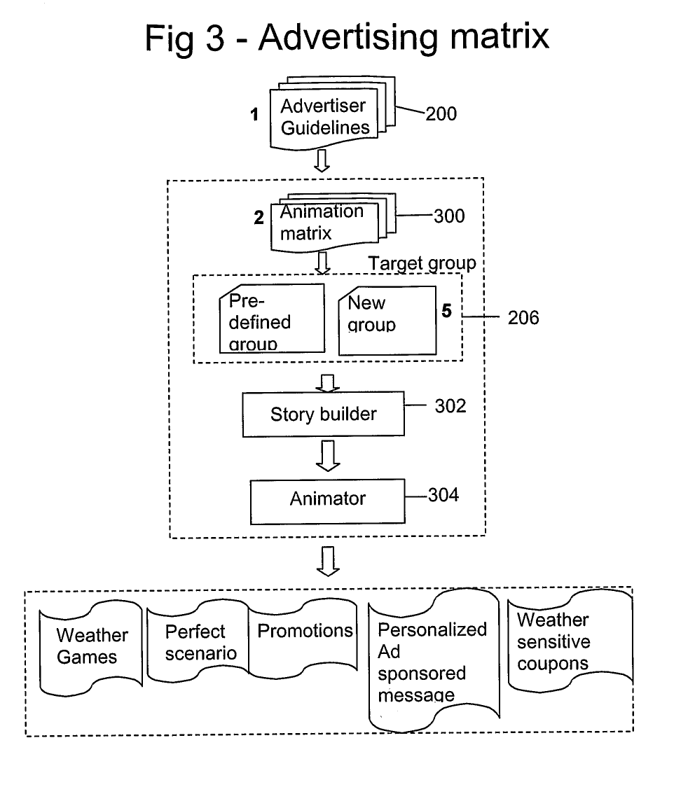

FIG. 3 shows advertising matrix 202 in more detail. Advertising matrix 202 can preferably handle at least several simple predefined groups and parameters, preferably up to a relatively large, multi layer three-dimensional matrix.

The advertiser has an option to adjust the advertising campaign to a highly detailed specific level, including up to the single consumer and this consumer's spending habits. This adjustment is preferably made by defining the parameter on which the campaign is based (through advertiser guidelines) into an Animation matrix 300. The advertiser can choose to use some of the existing predefined groups (out of the advertising rules) or the learning engine can optionally build a new group and subgroup(s) based on one or more specifications (not shown). Animation matrix 300 preferably stores the animation components and rules, and more preferably specifies different animation, pictures, slides, background colors etc. for different usage. These components are preferably selected according to rules that are more preferably determined according to target groups 206.

The selected components are preferably passed to a story builder 302, which builds a short animation (preferably based on the components received from Animation Matrix 300) or other personalized display that is customized to at least one end user characteristic, more preferably while maximizing the advertiser value (according to the advertiser strategy and predefined logic).

Next, story builder 302 provides the necessary information to an animator 304. The advertiser provides the guidelines for the animation and the multimedia i.e. the images, motions, advertisements, sound etc for provision to the end user.

Animator 304 preferably comprises an animation engine that creates the animation for displaying the weather related parameters, its background, story, Perfect scenario related graphical components (described in greater detail below), advertiser related graphics, animation and so forth. Various non-limiting examples of output from animator 304 are shown in FIG. 3.

Advertising matrix 202 preferably allows the advertiser to deploy a promotion strategy, preferably by specifying certain message(s)/campaign(s) for exposure to certain group(s), and subgroups, in the population. In addition, since the database optionally and preferably contained in advertising matrix 202 is preferably built in Java, it supports inheritance e.g. the various subgroups can inherit the group rules with one or more variations that differentiate them (of course any method that supports inheritance could optionally be used in place of Java).

For each cell, the message does not need to be a full message, but may be a partial message that is unique to the specific group (or subgroup). It is then the task of the Animation matrix, Rule engine, the Story builder, the animation engine and all the other components that are in direct link with the user to unite the various components/cells that are relevant to specific individual, under certain conditions into a personalized advertising/promotion campaign.

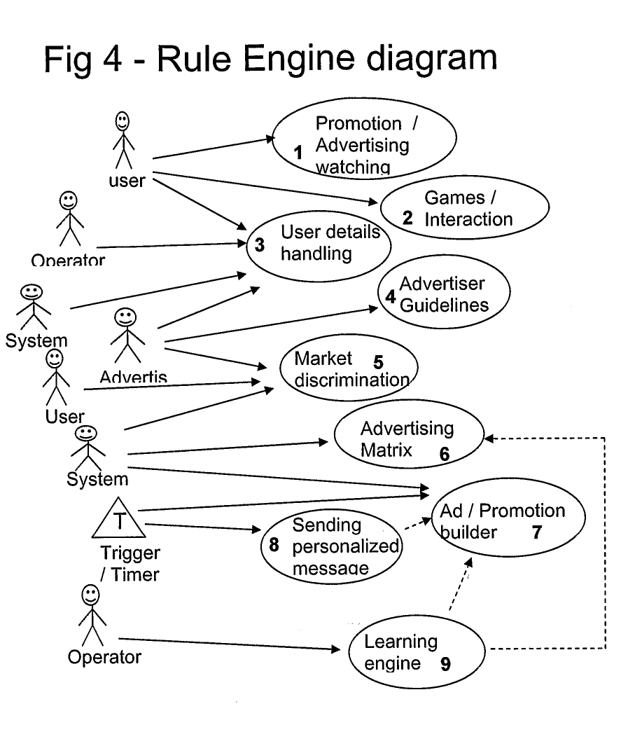

FIG. 4 shows a logic flow diagram related to the operation of the rule engine, through interactions with end users (user), system managers (operator), advertisers (advertiser) and the system according to the present invention (system).
1. Promotion Advertising watching: user obtains a personalized advertisement which is preferably personalized according to the user profile and specific weather/meteorological parameters that the user (or one of his/her friends, family members etc.) is experiencing at the same time or will experience in a certain time frame, preferably of several minutes to several hours. This time frame is preferably selected to be consonant with the time frame of weather prediction that is provided, for example through Nowcasting. The personalized advertisement is optionally and preferably embedded with a weather forecast that may optionally be obtained through personalized Nowcasting and/or through other methods of weather forecasting. The personalized advertisement is preferably sensitive to the user's location, hobbies, health, personal preferences and so forth. The personal advertisement preferably includes one or more of the following: static pictures (advertisement), short video clips, various tunes/music, coupons, promotions and the like. The user's location may optionally be determined according to the physical location of an electronic device known to be associated with the user (such as a cellular phone for example) and/or through input provided directly by the user and/or knowledge of the user's habits (for example, commuting to work at a particular time each day).
2. Games/Interaction: the user optionally and preferably enjoys, among other activities, weather based games in which the advertisement/promotion is embedded into the game and the user interacts with the system/the advertiser/the advertising campaign through user feedback, surveys, active participation in the advertiser's campaign and the like.
3. User detail handling: the system according to the present invention preferably collects and handles all user relevant details including but not limited to, user location, the expected weather in the user's location or the expected weather in the location of the user's family members or friends. When working with the Location-base Nowcasting server (NLS), preferably the user's basic information (current or future location, hobbies, favorite locations, skin type, allergies etc.) is supplied by the system according to collected details about the user. Additional information about the user optionally and preferably comes from the advertiser according to advertiser database. Additional information may optionally be obtained through inducing the user to provide particular details in return for free products and/or free services. In order to obtain free services/better service and other benefits, a user preferably can independently provide such details directly to the application through the mobile phone, computer, Web interface service, with the help of human assistant in the face of company (such as the advertiser) representative, through an automated telephone voice menu, using interactive TV, using various sorts of games and so forth.
4. Advertiser Guidelines: are provided by the advertiser regarding the advertising campaign, logic and strategy. The advertiser has the option to define and match certain weather related scenarios with certain groups to a specific advertising campaign, weather related coupons, games, promotion etc. The advertiser preferably has the capability to analyze the data in unlimited vertical and horizontal directions, from the level of a predefined user group up to the level of a single user with accurate time scale, specific weather parameters at a certain level and with regard to a particular location and so forth (preferably, the specific user's identity is blocked to the advertiser, although optionally one or more relevant details, such as the user's flavor preference for a soft drink, may be available to the advertiser). Therefore, the advertiser potentially can focus on the single user within the group or sub group at a particular time with a specific meteorological parameter. The advertiser optionally has the option to add, adjust and modify the strategy “on the fly” (dynamically, in real time) through a remote terminal and/or a Web-based interface and the like. The advertiser guidelines may also optionally include a set of icons, pictures, background, sounds, tunes, images messages, games, links, ring tones, weather related coupons and the like. The advertiser also preferably receives various reports and feedback with regard to the weather related advertising campaign and the effect the weather had on sales of the products and the effect of the campaign.
5. Market discrimination: organizes and slices the target market into a series of groups and sub groups according to advertiser demands and advertising strategy, preferably according to the predefined groups and also with respect to various meteorological parameters as well as Nowcasting parameters that are in the system. Personal details may optionally be used to sort the users into groups (could be predefined groups by the system or new groups that are formed automatically). Optionally, the advertising matrix and the learning engine sort the various users and potential users according to the advertiser's advertising strategy and guidelines, which may optionally be done according to the predefined groups and/or by creating new groups and subgroups. The data and updates with regards to a certain user or group preferably come from various sources, including but not limited to the user, the advertiser, the system, the wireless operator, ISP's, various databases, third party data providers and the like.
6. Advertising Matrix: comprises a database that includes the relevant advertising components (supplied by the advertiser, internal system databases, internal and external information suppliers and so forth) such as sound, images, games, coupons, etc., preferably classified into predefined groups with respect to predefined personalized parameters (age, gender, location, sensitivities, hobbies etc.), and then optionally and preferably calculated with regard to predefined meteorological conditions, optionally with respect to certain values (for example: predefined groups of teenage girls on the beach may optionally receive a special coupon to buy a diet drink when the effective temperature rises above a certain level).
7. Ad/Promotion builder: combining the various components of the advertising with regards to the various rules and with respect to certain/common meteorological parameters (under certain conditions), the ad builder is also responsible for the quality and sensitivity of the final outcome using the “Learning Engine” (previously described).
8. Sending personalized message: preferably adapted to the various media and platforms such as Mobile phones, Digital TV, the Web, Smart house, Imbedded devices, Smart devices, Automotive (for example in a device embedded in the dashboard or present in front of the seat of a passenger) for transmitting a message to the user.
9. Learning Engine: the learning engine is in charge of data integrity, in order to provide a logical product promotion that is also sensitive to user preferences and characteristics; for example, not advertising meat products to a vegetarian.

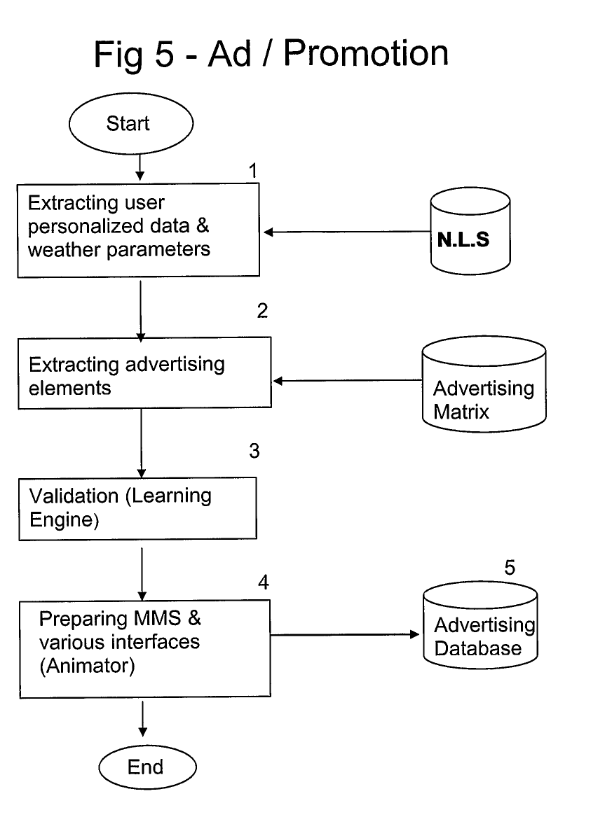

FIG. 5 shows the advertisement and promotion building process, which may optionally be performed with the story builder and animator as previously described. This process preferably features the following stages as shown:
1. Extracting user personalized data & weather parameters: the data is preferably extracted from a local server (shown as NLS 106 in FIG. 2) and/or other similar sources. The data preferably contains the relevant meteorological and Nowcasting parameters of the user. More preferably, the NLS also sends other relevant user personalized information as previously described.
2. Extracting advertising elements from the Advertising Matrix, combining it with the meteorological and Nowcasting elements to produce the advertisement/promotion.
3. Validation (Learning Engine): checking the above process for various technically false messages as well as any offensive or insulting messages and the like.
4. Preparing MMS & various interfaces (Animator): animate the final message and adjusting it to the specific handset, platform and method of communication, thereby producing various advertisements and messages as previously described.
5. Advertising Database: in order to save time and traffic, a common configuration of certain groups with certain advertising/promotional campaigns and with regard to certain meteorological parameters may optionally be used.

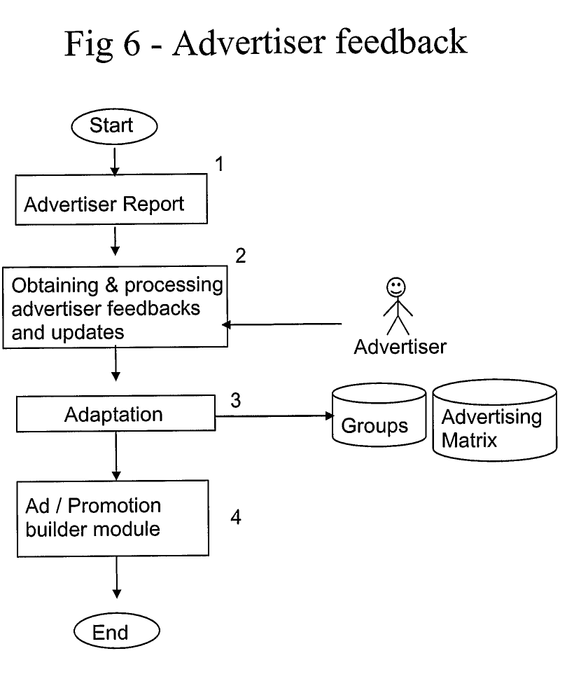

FIG. 6 shows an optional embodiment of the present invention for providing feedback to the advertiser.
1. Advertiser Report—generating advertising campaign related reports, statistics, updates such as:
   1.1 Number of times the advertisement was viewed/played etc with regards to the conditions (meteorological and the like) under which it was used.
   1.2 The use of coupons and other promotion aids with respect to the weather e.g. how effective was the new soft drink campaign with regards to the weather (at the specific time and location), optionally with regard to the time and place when the temperature reached a given level (more parameters can optionally be added). Also reports may optionally be provided that will indicate the specific temperature where the use of coupons is most effective may optionally be provided.
   1.3 Reports that indicate the level of correlation between various weather games and the use of the advertiser advertising and marketing tools (such as weather sensitive coupons, weather pending personalized advertisement, actual sales, effectiveness of promotion campaign with regard to the actual weather etc.), for example: as part of a weather game (into which the advertising campaign is integrated), one of the prizes/bonuses could optionally be a weather pending coupon (which is itself only usable under certain meteorological conditions and hence is optionally part of the game); the system preferably then tracks the effectiveness (under certain parameters) of the correlation between the weather game and the coupons, thereby providing feedback on the effectiveness of the advertising campaign (that in the above case integrates the advertiser coupon into a weather game).
   1.4 The effect that a specific weather parameter in a specific location has on certain promotion campaign including advertising, weather related coupons etc is preferably also examined.
2. Obtaining & processing advertiser feedbacks and updates may also optionally be performed; for example, the advertiser (via remote terminal or using automatic process such as a web based application or dedicated application that informs the advertiser of any update and report that originate from the invention or through third party analysis software such as B2B management software and other general/managerial aids as well as other sales, promotion and advertising tools that track, analyze and report with regard to the entire advertising/promotion campaign (of which weather pending promotion may only be a part), as well as feedback to and from sales point related software, database, and systems. This component may optionally update the advertising guide lines as well as the various images, sounds, animations, coupons, rules, games etc. The updates are for the advertiser in order to adjust and refine the message and advertising campaign with regards to the weather both from the historical and the expected weather point of view:
   2.1 Historical—in order to update the advertising guidelines, groups, animation, games etc. in order to create a better synergy between the weather and all other relevant advertising components.
   2.2 Expected—after receiving notification from the “recommendation module” or after other ways of which he learned of change in the expected weather. The advertiser may optionally decide to deploy on the fly an urgent campaign, for example when the advertiser learns that after several days of extreme weather there will be warm and sunny weather in a desired location just in time for a new activity/show/fair etc. The advertiser decides on the fly to combine the advertisement with the announcement of the change in the weather.
   2.3 Expected event—may optionally occur when the advertiser knows that a certain event is planned at a given location and at a certain time, such that the advertiser may want to combine a weather dependent advertisement, coupons, games and the like to a specific group at the event; for example, at a rock concert on the beach, the advertiser may want to promote a new light beer specifically designed for and targeted at young women.
3. Adaptation: using the new information to adjust the existing database including existing groups, create new groups, adjusting parameters on the advertising matrix and creating new ones.
4. Activating “Ad / Promotion builder” module that will build and check new advertising campaign modules.

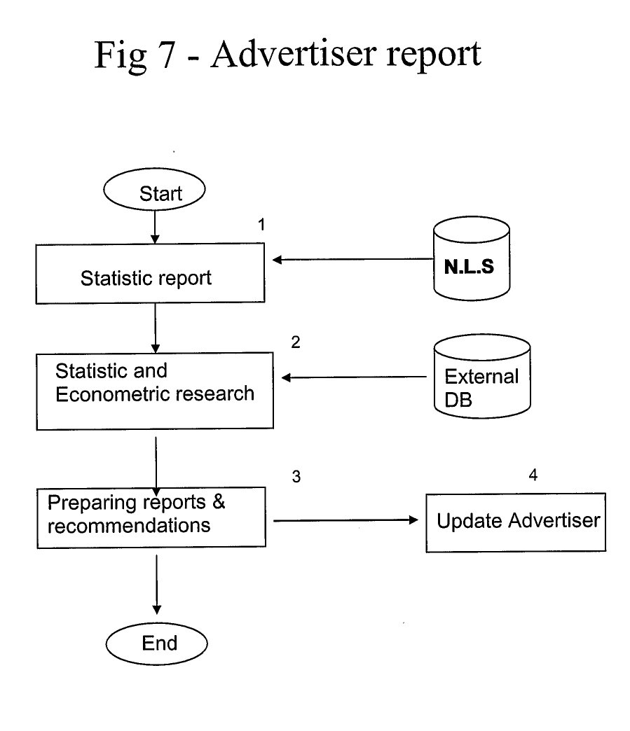

FIG. 7 shows various types of optional advertiser reports and a logic flow for creating such reports.
1. Statistic report: various statistical reports of all promotion related issues and variables with regard to the exact weather conditions at the time of the promotion campaign. The reports may optionally be created with regard to the metrological and other conditions before and after the relevant campaign (according to statistic needs and advertiser demand). The reports could optionally include data from external sources (meteorological and non meteorological) that will assist in the statistical analysis and reporting of the effectiveness of the weather pending promotion.

Statistic and Econometric research may also optionally be incorporated into the present invention and preferably involves conducting econometric and statistical research based on the effective exact weather conditions in a certain location at a given time (optionally including target groups and other personalization features in the system of the present invention as well as the various parameters of the Rule Engine) has on various marketing and sales tools such as: coupons (preferably not only weather related coupons), consuming habits, various users active and passive participation in various marketing and sales campaigns including games, life style, work and the like. In order to perfect the results the Econometric module results preferably connect to an external database which monitors the user's actual consuming habits such as the “Retalix” point-of-sale (POS) systems with the NCR RealScan bar-code scanners that allow the system to know in real time the exact product that was purchased, the time, the location, the means of payment (including whether the client used a weather related coupon or other promotional mechanisms, and the like). The system is not limited to barcode readers, cash registers and the like, and it could optionally (via Retalix or other manufacturer or database) use 3 G or higher wireless coupons or other means of payment, blue-tooth (or other wireless connection) and the like.

Using the Econometric engine, weather based research may also optionally be expanded to include research into agriculture and food commodity markets. The connection to the econometric research engine may optionally be performed through a dedicated database, terminals and the like. Optional embodiments of the present invention therefore preferably feature a statistic/economic method that measures the effect of a specific weather parameter at a certain level on consuming habits of a particular type or group of users, and optionally also the effectiveness of a certain promotion campaign on the sales of a certain products and also under which correlating conditions (such as in which temperature range the advertising for ice-cream is most effective, on which other parameters this result depends: age group, location, humidity, time of day, activities etc.).

3. Recommendations and reports: with the result of the statistic analysis and econometric studies the system issues an internal report (that will initiate the advertiser feedback process and will update the various groups, advertising matrix etc.) as well as external reports to the advertiser. The system will also generate recommendations for an advertiser with regard to maximizing the effect of an advertising and marketing campaign with regard to the weather and other relevant parameters; the system can recommend the advertiser to use alternative channels e.g. to add/reduce certain animation, to focus on certain groups, to edit existing groups, to focus on the campaign around certain weather parameters in certain values, to increase/decrease the use of weather coupons (or other coupons), recommendations with regards to the effectiveness of weather games and other weather pending marketing tools.

4. The system may optionally initiate contact to advertisers that are not currently advertising when there is a certain change in the expected weather. Optionally, the system analyzes the advertiser's capability to benefit from the expected change in the weather and offers the advertiser several effective ways (divided according to a cost effective scale) to promote the product/service.

Various non-limiting examples of advertisements and messages are described in greater detail below.

Free products and coupons: a user of the present invention is preferably offered free products and coupons. Before receiving the free product, the user will be asked to answer several questions such as: what is your favorite flavor? Do you prefer diet products? and so forth. It is also possible that the system will remember the product that the user chose (preferably from a certain range of products) and will determine whether that selection is the user's favorite product (out of the offered selection) for future advertising.

Optionally additional services of the system according to the present invention: the system of the present invention or other software (such as a mapping service) that integrates Location-base Nowcasting information would preferably be supplied free of charge to a user, or with a substantial discount, in return for disclosure of the user's consuming preferences (for example, by filling in some sort of questionnaire) and also agreement by the user to receive advertisements.

4. Weather sensitive coupons: For the Weather sensitive coupons there are four main objectives:

1. Retrieving user related data for statistic use, for internal use—the Learning engine, and for product promotion use.

2. In order to physically bring the user to a specific location or in order to let the user/client to visit a virtual location (such as certain company website).

3. In order to promote certain products, services and the like.

4. In order to influence the user to buy specific product and or from specific vendor etc.

As distinct from currently available coupons, which are based on proximity to a certain location, the Weather sensitive coupons of the present invention are preferably active mainly when the probability that they will be used is the highest. The selection of such a coupon is preferably made according to the user profile and the crucial effect that the weather has on the user's consumption decision process at a specific moment in time and at a specific location. A significant challenge with coupons is to cause as many suitable individuals (those who match a desired profile) to use the coupons. One advantage of the Weather sensitive coupons lies in the connection to the weather Nowcasting system and to the user profile, optionally including historical weather and Nowcasting consuming history. From an analysis of a certain profile (or group of profiles), the Learning engine can optionally select the individuals who are more sensitive to various weather parameters and use that information while building targeted coupons and advertisement campaigns.

The Weather sensitive coupons preferably use the effect of weather on consuming habits with regard to variety of products. Naturally the weather is not the only parameter that affects the urge but with a large variety of products it is the one of the strongest.

According to preferred embodiments of the present invention, the user preferences may optionally be stored in a matrix format. A non-limiting example is given below for an advertising campaign for a cola (soft drink).

| | | Predefine | | | | Favorite | | |
|---|---|---|---|---|---|---|---|---|
| Age | Sex | group | Location | Time | Hobbies | product | Preferences | History |
| 12-14 | F | Pink teen | Beach | Midday | Pop | Cola | Regular | |
| | | | | | music, | | | |
| | | | | | beach | | | |
| | Girls | Scenario | Beach | Fun | Madonna | Using | Regular | |
| | campaign | GP1(+3)* | background | animation | melody | Cola | | |
| 12-14 | F | Pink teen | Beach | Evening | Pop | Cola | Regular | |
| | | | | | music, | | | |
| | | | | | beach | | | |
| | Girls | Scenario | Beach | Romantic | Madonna | Using | | |
| | campaign | GP1(+3)* | background | animation | romantic | Cola | | |
| | | | | | melody | | | |
| *Scenario GP1(+1) = is a special scenario that fits to a predefined group code name “Pink teen”, GP is the code for the commercial campaign that fits (optionally among others) to the “Pink teen” group while 1 represents the specific basic clip**, (+3) represent the different basic clip (out of the GP group) that will be shown on the wireless device, and | | | | | | | | |
| # which will be changed depend upon conditions such as time, change of user preferences etc. to the next clip in the series (in this case GP3). | | | | | | | | |

**Basic clip: a basic clip is the master clip on which the Rule engine builds its unique multimedia and animation that will fit the requests of the advertiser in the Advertising Matrix.

According to other preferred embodiments of the present invention, there is provided a type of advertising message called the Perfect Scenario. The Perfect scenario is an animated based display that shows specific and customized weather/nowcast parameters. It preferably provides a story, more preferably a vivid animated story (which could optionally feature several changing characters or even just background slide) that presents the Perfect scenario for one individual (e.g. for a fisherman a nice day, nice sea and plenty of fish is a kind of Perfect scenario) while the only part that is missing (in order to create the “Perfect scenario”) is the right weather parameter i.e. the location-based Nowcasting that is shown together with the advertiser's product/message.

The Perfect scenario is preferably based on the Advertiser guidelines, the user profile (and the various groups that he belongs to); it is built within the Animation matrix and become vivid using the rules of the Storyboard.

A non-limiting example of such a scenario is described below.

The Story builder preferably builds a Perfect Scenario type of animation such as perfect day at the ballgame; in the ballgame example the crowd goes wild when the user favorite team scores. For this example the user measures the effective temperature at the stadium with the active crowd (that serves as a chart) while the advertisement is embedded in various places in the relevant area e.g. the area which is relevant to the story including embedded advertising and other relevant information in various details within. For example, the telephone or other device may optionally display an animated crowd to form the active crowd acting as a graph of the temperature and/or other weather parameters.

For example; in an ice-cream campaign, some of the individuals in the (animated) crowd displayed on the telephone may optionally be eating ice-cream (in the user's favorite flavor and/or new flavors that are being promoted); more preferably, as the temperature increases (most preferably determined according to nowcasting and presented by the animated graph featuring the “active crowd”), the animated graph display preferably increases the number of cheerful individuals among this crowd who are eating ice-cream in the user's favorite flavor. Moreover, additional messages and advertising could optionally be inserted in the relevant area (i.e. the story area on the screen) such as on the field, sidelines, on the players' shirts etc.

In the above example the ice-cream helps the scenario to become “perfect”; the user preferably uses it to measure weather related Nowcasting, the Storyboard preferably uses it to build a “perfect” picture according to the user preferences, all of which enables the advertiser to create a link with the success and the happy feeling.

Another non-limiting example of a perfect scenario is a new mother example. In the “new mother” example, the advertiser is optionally a baby care products provider while the new mother is the end user.

At her mobile phone screen, the new mother optionally sees an image/animation of her baby (and/or a generic baby image). The baby is preferably dressed with clothes appropriate to the current temperature, and at the side the mother preferably sees a kind of gauge that tells the temperature at a desired location; the gauge shows how the temperature/effective temperature will decrease (preferably as a function of time). At the same time the baby animation may optionally react to the decreased temperature by an unhappy look and sounds. The baby is happy again when the clothing is changed to warmer clothing, preferably of the advertised brand.

In case the weather is sunny such that there is a high level of UV radiation, the baby is preferably shown as being happy after using the advertised brand of suntan lotion; alternatively in case of rain the baby is preferably shown as being happy again after using the advertiser's umbrellas or other rain-related equipment etc.

The example is not limited to the use of “weather related” products and can also be used with a wide variety of products.

The advertising can be implemented in various places in the relevant area as well; at the background, in and/or as the gauge/measuring instrument, as the weather presentation method; for example e.g. a company can use its logo/mascot as a tool to measure the weather—as a kind of “babies weather forecaster” for infants for example. The icon/company logo/mascot can optionally and preferably react to the weather in a way that will allow the user to identify weather change(s) e.g. in case of light rain the icon can optionally wear a coat while light rain is shown in the background; for strong rain, the rain animation may also change while the image is optionally shown as using an umbrella etc.

According to preferred embodiments of the present invention, the goal of the Story builder is to combine some of the system basic information (such as gender, age, location, type of weather, expected weather, preferences etc.) and to integrate it with the promotion strategy and logic (using the Advertising Rules and the Advertising Matrix) together with the story builder.

The story builder preferably integrates 3 groups of data (User, Advertiser, Weather) into an animation (that can be regarded as a short story) which provides to the user a compelling vivid view.

Weather Game: Users can optionally be contacted to guess certain weather parameter for certain location (one or several) at a specific time or various averages i.e. hour average, day average week etc. or picks i.e. highest temperature/lowest. Wind velocity (high/low), rainfall (the exact amount) that falls in a certain location etc.

In order to get an educated guess of the expected weather, the user will be able to retrieve specific weather information, including weather parameters that are not available with the regular service according to the present invention such as live reading from certain weather station, web-cam that shows live pictures, statistics and analyze by 3^{rd} party (professional and other users/players) and more.

In the game, users are requested to place their bets/guesses at a certain time prior to the measurement time or any other preset deadline; the user can optionally change/adjust the guess/forecast in a certain window of time. The time at which the user made the first guess may optionally increase the final score calculation; the same principle will apply on updates that were made.

The winner will be the one with the highest score.

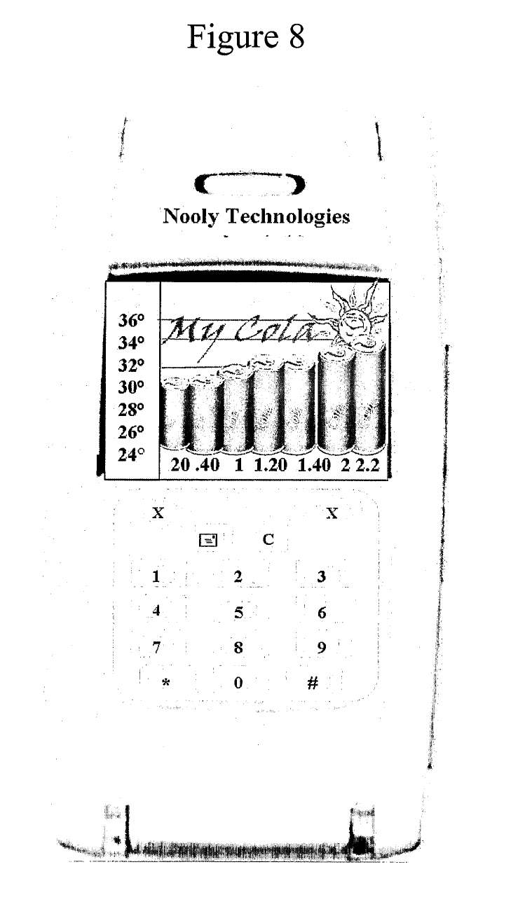

FIG. 8 shows another optional embodiment of the present invention for a format for providing weather-based advertisement. As shown, an image is preferably provided to the user (for example through a cellular telephone) in which weather information (shown here as temperature) is provided by using symbols related to the product being promoted (shown here as cola soft drinks).

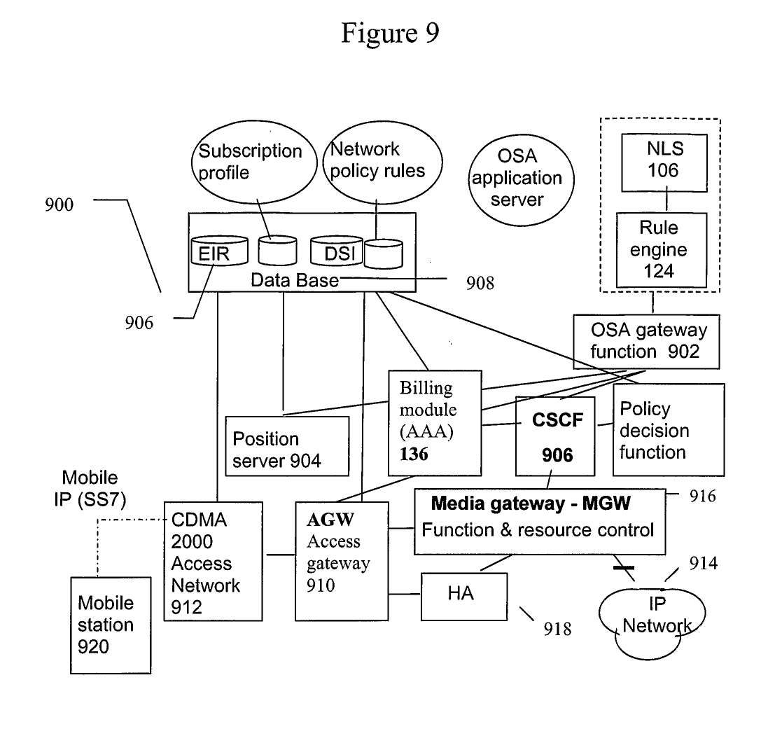

As previously described, according to optional embodiments of the present invention, an advertisement and/or other message as described herein is provided to the user through a wireless device such as a cellular telephone. FIG. 9 shows an illustrative, non-limiting system according to the present invention, featuring Rule Engine integration with a CDMA 2000 network (3 G network).

Rule engine 124 (optionally embedded into NLS 106 or as a stand alone) is preferably hosted on equipment in the Wireless Network Operator's (WNO) network 900 as part of the operator “Home Network”, in the Internet or in a private network. In this example, WNO 900 is described as operating according to CDMA 2000 3 G for the purposes of discussion only and without any intention of being limiting (see for example www.3gpp2.org/Public_html/specs/S.R0037-0_v2.0.pdf; www.3gpp2.org/Public_html/specs/tsgs.cfm and www.3gpp2.org/Public_html/Misc/v&vindex.cfm for a discussion of the standards and protocols involved).

Rule Engine 124 preferably connects to the wireless operator using the Qualcomm dedicated Brew platform (a C++ base OS by Qualcomm; present in CDMA 2000 (and other 3G platforms), Brew clients also run on the handsets of the cellular telephones and/or other wireless devices in the network, in Rule engine 124, and also in all major components of the system; Brew is equivalent to J2ME and J2EE with regard to many aspects of functionality). Rule Engine 124 uses standard APIs (e.g., OSA—“Open Service Access”—API), supported by OSA Gateway Function 902. The APIs allow access to rule engine 124 during SIP (Session Initiation Protocol) sessions (which are used for interactions between any two system components of WNO 900; SIP is the standard (RFC3261) designated call control protocol for all major IP 3 G networks (see www.sipcenter.com for more details)). The APIs also allow rule engine 124 to access resources in the network (e.g. Position Server 904, CSCF—“Cell Session Control Function” 906 (which controls interactions with the handsets), and billing module 136). Position Server 904 gives Rule Engine 124 the user location (or any other third party location) when necessary.

Billing module 136 preferably comprises an AAA, which provides IP based Authentication, Authorization (both of which are preferably used for the personalization process, including an interaction with the learning Engine and the advertising matrix, as they provide authentication of the user and hence support personalization), and Accounting (operates with regard to billing). Rule engine 124 preferably receives, through position server 904 and billing module 136, details and parameters with regard to the user handsets through EIR (Equipment Identity Register) module 906 (contained in a database 908). Rule engine 124 also preferably receives details and parameters with regard to existing applications and the user profile, and optionally receives as well as all other DSI (Dynamic Subscriber Information) that is stored in database 908, through position server and billing module 136. The relevant information is fed into rule engine 124 as shown.

While accessing functionality in WNO 900, rule engine 124 may also access private databases, SIP or http servers, and other functionality on equipment provided by a third party using various protocols (such as XML (Extensible Markup Language) or DDE (Dynamic Data Exchange standard) and/or other well known protocols) through IP network 914 using a secure gateway 916.

Rule engine 124 may optionally have bearer access to WNO 900, allowing a higher QoS (Quality of Service) than public Internet.

The result is preferably that personalized advertisements and promotions are provided to WNO 900 according to a format based on the Brew operating system through OSA gateway 902 using the SIP protocol (not limited). Access gateway 910 arranges the information with respect to the user handset location, location of the currently operating cell for that user handset and so forth.

Previously described wireless advertising/content (preferably only for multimedia components) is provided to WNO 900 through OSA gateway 902 to the CSCF (Call Session Control Function) in secure gateway 916, which preferably establishes, monitors, supports, and releases Multimedia sessions and manages the user's service interactions.

HA (mobile IP Home Agent) 918 handles registration, forwarding and receiving data with regard to the advertisement, promotion, weather game interactions and so forth according to the Mobile IP (IPv4 protocol. HA 918 preferably handles addressing of the correct data to the correct user, for example with regard to authentication related issues. Access gateway 910 presents the cellular telephone operator network (described in greater detail below) with a common interface to the specific capabilities, configuration, and resources of the numerous Access Network technologies, which may be provided through CDMA 2000 Assess Network 912 to the specific cell and user using the SS7 protocol.

Access gateway 910 supports the Multimedia and Legacy MS Domains, as well as BCMCS, which is a core network function that is responsible for managing and providing the BCMCS session information to the BSN function and to the RAN—(Radio Access Network—the actual network). Access gateway 910 may optionally be implemented as CDMA2000®1 Access Gateway (AGW), which features Packet Data Service Node (PDSN), which is equivalent to 3 G. These logical functions are required to interface the core network to CDMA 2000 Access Network 912.

Access gateway 910 provides the Core Network (CN), which is the operator network including mobile station 920, with access to the resources of Access Network 912. Access gateway 910 presents the operator network with a common interface to the specific capabilities, configuration, and resources of the numerous Access Network 912 technologies.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method for delivering a weather-related advertisement to an individual, the method comprising:
selecting the weather-related advertisement according to weather information about expected weather conditions, said expected weather conditions being related to a geographically confined area and a defined period of time; and
delivering said weather-related advertisement to the individual.

2. The method of claim 1, wherein the individual receives the weather information through a wireless device.

3. The method of claim 2, wherein said wireless device comprises a display screen, and wherein said advertisement is displayed in conjunction with said weather information on said display screen.

4. The method of claim 2, wherein said advertisement is selected according to said wireless device.

5. The method of claim 4, wherein said advertisement is selected according to a physical location of said wireless device.

6. The method of claim 4, wherein said advertisement is selected according to the individual subscribing to said wireless device.

7. The method of claim 21, wherein said advertisement is delivered with said weather information.

8. The method of claim 1, wherein said advertisement is also selected according to a parameter defined by the individual.

9. The method of claim 1, wherein the individual receives the weather information through a display, and wherein said advertisement is displayed in conjunction with said weather information on said display.

10. The method of claim 9, wherein said display comprises at least one of a billboard, a hoarding, a sign and a displayed Web page.

11. The method of claim 1, wherein said advertisement is delivered according to at least one rule.

12. The method of claim 11, wherein said advertisement is selected according to a plurality of rules by a rule engine.

13. The method of claim 12, wherein said rule engine comprises a learning engine for learning at least one aspect of the user preference(s) and/or consuming habit(s) according to the weather.

14. The method of claim 1, wherein said advertisement is built according to a scenario determined at least partially according to a prediction of the weather.

15. The method of claim 14, wherein said advertisement comprises a storyboard also built and/or selected according to at least one user preference.

16-21. (canceled)

22. A system for providing weather-related advertising to a user through an electronic device, comprising: (a) a weather server for providing at least one weather related parameter; (b) an advertising rule engine for selecting an advertisement at least partially according to said at least one weather related parameter; and(c) a server for serving said advertisement to the electronic device.

23. The system of claim 22, wherein said rule engine further comprises a database for storing at least one user characteristic and for selecting said advertisement also according to said user characteristic.

24. The system of claim 23, wherein said rule engine comprises an advertising matrix for selecting said advertisement according to a plurality of rules.

25. The system of claim 24, wherein said rule engine comprises a plurality of target groups and wherein said advertising matrix selects a target group for the end user, such that said advertisement is selected according to said target group.

26. The system of claim 24, wherein said advertising matrix further comprises a story builder for building an advertisement according to a plurality of components.

27. The system of claim 26, wherein said advertising matrix further comprises an animation matrix for providing a plurality of animated components, such that said plurality of components for building said advertisement comprise animated components.

28. The method of claim 1, wherein said weather information is determined according to location-based nowcasting.

29. The method of claim 1, wherein the advertisement is delivered to a plurality of individuals having at least one similar characteristic.

30. The method of claim 13, further comprising:
determining efficacy of an advertisement on a consumer activity of the individual by said rule engine.

31. The method of claim 1, wherein said expected weather conditions comprise one or more of a temperature range, effective temperature, humidity, a rain pattern, hail, snow, ice, pollen count, dust level, air pollution level or UV radiation.

32. A method for delivering weather-related content to an individual, the method comprising:
selecting the weather-related content according to expected weather conditions, said
expected weather conditions being related to a geographically confined area and a defined period of time; and
delivering said weather-related content to the individual.
